(19) United States
(12) Patent Application Publication
(10) Pub. No.: US 2009/0012207 A1
(43) Pub. Date: Jan. 8, 2009

(54) USE OF COLOURED POLYMERIC SYSTEMS FOR MEDICAL OR HYGIENE ARTICLES

(75) Inventors: Reinhold J. Leyrer, Dannstadt-Schauernheim (DE); Wendel Wohlleben, Mannheim (DE); Stephan Altmann, Deidesheim (DE); Thomas Daniel, Waldsee (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF SE, Ludwigshafen (DE)

(21) Appl. No.: 12/279,188

(22) PCT Filed: Feb. 13, 2007
(86) PCT No.: PCT/EP2007/051372

§ 371 Date: Aug. 13, 2008

(30) Foreign Application Priority Data
Feb. 21, 2006 (EP) 06110195.2

(51) Int. Cl. C08L 33/02; C08L 33/10

(52) U.S. Cl. 523/111; 523/105

(57) ABSTRACT

Use of colored polymer systems having a color which is changeable in the case of a strain for indicating the stress state of hygiene or medical articles adjacent to the body.

The invention relates to the use of colored polymer systems having a color which is changeable in the case of a strain and is intended for indicating the stress state of hygiene or medical articles adjacent to the body.

Aqueous polymer dispersions are economical organic materials which are easy to prepare. DE-A 197 17 879 and DE-A 198 20 302 have disclosed that special polymer dispersions are suitable for the preparation of polymer systems comprising polymer particles and matrix, and these polymer systems exhibit a Bragg reflection. Embodiments of these polymer dispersions and their use are also to be found in DE-A 103 21 083, DE-A 103 21 079, DE-A 103 21 084 and in the German patent application not yet published on the date of filing of this application and having the application numbers 10 2005 023 804.1, 10 2005 023 806.8, 10 2005 023 802.5 and 10 2005 023 807.6.

The use of such polymer systems for the production of optical display elements is described in DE-A 102 29 732. In the display elements, color changes are brought about by the change of the spacings between the polymer particles dispersed in the matrix. The cause of the changes in spacing may be, for example, the action of mechanical forces or electric fields.

Further uses of the polymer systems were an object of the present invention.

Accordingly, the use defined at the outset was found.

The polymer system is a system comprising polymer particles and a deformable material (matrix), the polymer particles being distributed in the matrix according to a defined space lattice structure.

Regarding the polymer particles

For the formation of a defined space lattice structure, the discrete polymer particles should as far as possible be of the same size. A measure of the uniformity of the polymer particles is the so-called polydispersity index, calculated according to the formula

P.I.=(D90−D10)/D50

where D90, D10 and D50 are particle diameters for which the following applies:

D90:90% by weight of the total mass of all particles have a particle diameter of less than or equal to D 90

D50:50% by weight of the total mass of all particles have a particle diameter of less than or equal to D 50

D10:10% by weight of the total mass of all particles have a particle diameter of less than or equal to D 10.

Further explanations of the polydispersity index are to be found, for example, in DE-A 197 17 879 (in particular drawings, page 1).

The particle size distribution can be determined in a manner known per se, for example using an analytical ultracentrifuge (W. Mächtle, Makromolekulare Chemie 185 (1984), pages 1025-1039) and the D 10, D 50 and D 90 value can be derived therefrom and the polydispersity index determined.

The polymer particles preferably have a D 50 value in the range from 0.05 to 5 mm. The polymer particles may comprise one particle type or a plurality of particle types having different D 50 values, each particle type preferably having a polydispersity index of less than 0.6, particularly preferably less than 0.4 and very particularly preferably less than 0.3 and in particular less than 0.15.

In particular, the polymer particles now consist of a single particle type. The D 50 value is then preferably from 0.05 to 2 mm, particularly preferably from 100 to 400 Nanometer.

Polymer particles which consist, for example, of 2 or 3, preferably 2 particle types differing with respect to the D 50 value can also form a common lattice structure (crystallized) if the above condition with regard to the polydispersity index is fulfilled for each particle type. For example, mixtures of particle types having a D 50 value of from 0.3 to 0.5 mm and having a D 50 value of from 0.1 to 0.3 mm are suitable.

The polymer particles preferably consist of a polymer having a glass transition temperature greater than 30° C., particularly preferably greater than 50° C. and very particularly preferably greater than 70° C., in particular greater than 90° C.

The glass transition temperature can be determined by conventional methods, such as differential thermal analysis or Differential Scanning Calorimetry (cf. for example ASTM 3418/82, so-called “mid-point temperature”).

The polymer preferably comprises at least 40% by weight, preferably at least 60% by weight, particularly preferably at least 80% by weight, of so-called main monomers.

The main monomers are selected from C1-C20-alkyl (meth)acrylates, vinyl esters of carboxylic acids comprising up to 20 carbon atoms, vinylaromatics having up to 20 carbon atoms, ethylenically unsaturated nitriles, vinyl halides, vinyl ethers of alcohols comprising 1 to 10 carbon atoms, aliphatic hydrocarbons having 2 to 8 carbon atoms and 1 or 2 double bonds or mixtures of these monomers.

Alkyl (meth)acrylates having a C1-C10-alkyl radical, such as methyl methacrylate, methyl acrylate, n-butyl acrylate, ethyl acrylate and 2-ethylhexyl acrylate, may be mentioned by way of example.

In particular, mixtures of the alkyl (meth)acrylate are also suitable.

Vinyl esters of carboxylic acids having 1 to 20 carbon atoms are, for example, vinyl laurate, vinyl stearate, vinyl propionate, vinyl versatate and vinyl acetate.

Suitable vinylaromatic compounds are vinyltoluene, a- and p-methylstyrene, alpha-butylstyrene, 4-n-butylstyrene, 4-n-decylstyrene and preferably styrene. Examples of nitriles are acrylonitrile and methacrylonitrile.

The vinyl halides are ethylenically unsaturated compounds substituted by chlorine, fluorine or bromine, preferably vinyl chloride and vinylidene chloride.

For example, vinyl methyl ether or vinyl isobutyl ether may be mentioned as vinyl ethers. Vinyl ethers of alcohols comprising from 1 to 4 carbon atoms are preferred.

Butadiene, isoprene and chloroprene may be mentioned as hydrocarbons having 2 to 8 carbon atoms and one or two olefinic double bonds, and ethylene or propylene as an example of those having a double bond.

The C1- to C20-alkyl acrylates and methacrylates, in particular C1- to C8-alkyl acrylates and methacrylates, vinylaromatics, in particular styrene, and mixtures thereof, in particular mixtures of the alkyl(meth)acrylates and vinylaromatics are preferred as main monomers.

Methyl acrylate, methyl methacrylate, ethyl acrylate, n-butyl acrylate, n-hexyl acrylate, octyl acrylate and 2-ethylhexyl acrylate, styrene and mixtures of these monomers are very particularly preferred.

The polymer particles are preferably chemically crosslinked. For this purpose, monomers having at least two polymerizabale groups, e.g. divinylbenzene or allyl methacrylate, may be concomitantly used (internal crosslinking). However, it is also possible to add crosslinking agents (external crosslinking).

Regarding the matrix

There should be a difference in the refractive index between the matrix and the polymers.

The difference should preferably be at least 0.01, particularly preferably at least 0.1.

Either the matrix or the polymer may have the higher refractive index. What is decisive is that a difference exists.

The matrix consists of a deformable material. Deformability is understood as meaning that the matrix permits three-dimensional displacement of the discrete polymer particles on application of external forces (e.g. mechanical, electromagnetic).

The matrix therefore preferably consists of an organic material or organic compounds having a melting point or a glass transition temperature below 20° C., particularly preferably below 10° C., very particularly preferably below 0° C. (at 1 bar).

Organic compounds having a melting point or a glass transition temperature (Tg) above 20° C. are also suitable, but interim heating to above the melting point or the Tg is required here if the spacings of the polymer particles are to be changed (see below).

Liquids, such as water, or liquids having a higher viscosity, such as glycerol or glycol, are suitable.

Polymeric compounds, e.g. polycondensates, polyadducts or polymers obtainable by free radical polymerization, are preferred.

For example, polyesters, polyamides, formaldehyde resins, such as melamine-, urea- or phenol-formaldehyde condensates, polyepoxides, polyurethanes or the abovementioned polymer which comprise the main monomers mentioned, e.g. polyacrylates, polybutadienes and styrene/butadiene copolymers, may be mentioned.

Regarding the preparation

Preparation methods are described in DE-A 197 17 879 and DE-A 198 20 302.

Preparation of the discrete polymer particles.

The preparation of the polymer particles or polymer is effected in a preferred embodiment by emulsion polymerization; said polymer is therefore an emulsion polymer.

The emulsion polymerization is preferred in particular because polymer particles having a uniform spherical shape are obtainable in this manner.

However, the preparation can also be effected, for example, by solution polymerization and subsequent dispersing in water.

In the emulsion polymerization, ionic and/or nonionic emulsifiers and/or protective colloids or stabilizers are used as surface-active compounds.

A detailed description of suitable protective colloids is to be found in Houben-Weyl, Methoden der organischen Chemie, volume XIV/1, Makromolekulare Stoffe, Georg-Thieme-Verlag, Stuttgart, 1961, pages 411 to 420. Suitable emulsifiers are anionic, cationic and nonionic emulsifiers. Emulsifiers whose molecular weight, in contrast to the protective colloids, is usually below 2000 g/mol are preferably used as surface-active substances.

The surface-active substance is usually used in amounts of from 0.1 to 10% by weight, based on the monomers to be polymerized.

Water-soluble initiators for the emulsion polymerization are, for example, ammonium and alkali metal salts of peroxodisulfuric acid, e.g. sodium peroxodisulfate, hydrogen peroxide or organic peroxides, e.g. tert-butyl hydroperoxide.

Reduction-oxidation (redox) initiator systems are also suitable.

The redox initiator systems consist of at least one generally inorganic reducing agent and an inorganic or organic oxidizing agent.

The oxidizing component is, for example, one of the abovementioned initiators for the emulsion polymerization.

The reducing components are, for example, alkali metal salts of sulfurous acid, such as, for example, sodium sulfite or sodium hydrogen sulfite, alkali metal salts of disulfurous acid, such as sodium disulfite, bisulfite addition compounds of aliphatic aldehydes and ketones, such as acetone bisulfite, or reducing agents such as hydroxymethanesulfinic acid and salts thereof, or ascorbic acid. The redox initiator system can be used with concomitant use of soluble metal compounds whose metallic component may occur in a plurality of valency states.

Conventional redox initiator systems are, for example, ascorbic acid/iron(II) sulfate/ sodium peroxidisulfate, tert-butyl hydroperoxide/sodium disulfite, tert-butyl hydroperoxide/sodium hydroxymethanesulfinate. The individual components, for example the reducing component, may also be mixtures, for example a mixture of the sodium salt of hydroxymethanesulfinic acid and sodium disulfite.

The amount of the initiator is in general from 0.1 to 10% by weight, preferably from 0.5 to 5% by weight, based on the monomers to be polymerized. It is also possible to use a plurality of different initiators in the emulsion polymerization.

The emulsion polymerization is effected as a rule at from 30 to 130° C., preferably from 50 to 90° C. The polymerization medium may consist either only of water or of mixtures of water and liquids miscible therewith, such as methanol. Preferably, only water is used. The emulsion polymerization can be carried out either as a batch process or in the form of a feed process, including step or gradient procedure. The feed process is preferred, in which a part of the polymerization batch is initially taken, heated to the polymerization temperature and prepolymerized and then the remainder of the polymerization batch is fed continuously, stepwise or with superposition of a concentration gradient to the polymerization zone, usually via a plurality of spatially separated feeds, one or more of which comprise the monomers in pure or in emulsified form, while maintaining the polymerization. During the polymerization, a polymer seed may also be initially taken, for example for better establishment of the particle size.

The manner in which the initiator is added to the polymerization vessel in the course of the free radical aqueous emulsion polymerization is known to the average person skilled in the art. It may either be completely initially taken in the polymerization vessel or used continuously or stepwise at the rate at which it is consumed in the course of the free radical aqueous emulsion polymerization. Specifically, this depends on the chemical nature of the initiator system as well as on the polymerization temperature. Preferably, a part is initially taken and the remainder is fed to the polymerization zone at the rate of consumption.

A uniform particle size distribution, i.e. a low polydispersity index, is obtainable by measures known to the person skilled in the art, for example by varying the amount of surface-active compound (emulsifier or protective colloid) and/or appropriate stirrer speeds.

For removing the residual monomers, initiator is usually added even after the end of the actual emulsion polymerization, i.e. after a monomer conversion of at least 95%.

The individual components can be added to the reactor in the feed process from above, at the side or from below through the bottom of the reactor.

In the emulsion polymerization, aqueous dispersions of the polymer, as a rule having solids contents of from 15 to 75% by weight, preferably from 40 to 75% by weight, are obtained.

Preparation of the polymer particle / matrix (layer) mixture

Water or solvent as matrix

In the emulsion polymerization, an aqueous dispersion of the polymer particles is obtained directly. The water can easily be removed until the lattice structure of the polymer particles, detectable from the observable color effects, is established.

If any further solvents are desired water can be exchanged in a simple manner for these solvents.

Polymeric compounds as matrix

The aqueous dispersion of the discrete polymer particles which is obtained in the emulsion polymerization can be mixed with that amount of the polymeric compound which is required for establishing the lattice structure and the water can then be removed. Owing to the often high viscosity of the polymeric compound, it may be advantageous first to mix the polymer particles with the synthesis components of the polymeric compound and then, after dispersing of the polymer particles is complete, to react the synthesis components, for example by condensation or adduct formation, to give the polymeric compounds.

Emulsion polymers as discrete polymer particles and emulsion polymers as matrix

Emulsion polymers as discrete polymer particles and emulsion polymers as matrix are preferred

The corresponding emulsion polymer can be easily mixed and then the water removed. If the emulsion polymers for the matrix have a glass transition temperature below 20° C. (see above) the polymer particles form a film at room temperature and form the continuous matrix; in the case of a relatively high Tg, heating to temperatures above the Tg is required.

It is particularly easy and advantageous to prepare both emulsion polymers in one step as a core/shell polymer. For this purpose, the emulsion polymerization is carried out in 2 stages. First, the monomers which form the core (=subsequent discrete polymer particles) are polymerized and then, in a 2nd stage, the monomers which form the shell (=subsequent matrix) are polymerized in the presence of the core.

When the water is subsequently removed, the soft shell, whose glass transition temperature is below 20° C., forms a film, and the remaining (hard) cores are distributed as discrete polymer particles in the matrix.

The polymer particles are therefore particularly preferably the core of core/shell polymers, and the matrix is formed by the film formation of the shell.

The spacing between the polymer particles is preferably from 100 to 400 nanometers, so that electromagnetic radiation in the range of visible light is reflected (Bragg reflection).

Core/shell polymers obtainable by emulsion polymerization are particularly preferred in the context of the present invention.

Particularly suitable embodiments of the core/shell emulsion polymer are to be found in DE-A 197 17 879, DE-A 198 20 302, DE-A 103 21 083, DE-A 103 21 079, DE-A 103 21 084 or in the German patent application not yet published on the date of filing of this application and having the application numbers 10 2005 023 804.1, 10 2005 023 806.8, 10 2005 023 802.5 and 10 2005 023 807.6.

The polymeric compounds may also be crosslinked, so that they have elastic properties. If crosslinking is desired, it is preferably effected during or after the film formation, for example by thermally or photochemically initiated crosslinking reaction of a crosslinking agent which is added or may already be bonded to the polymer.

The crosslinking of the matrix produces a restoring force which acts on the discrete polymer particles. Without the action of external forces, the polymer particles then assume the predetermined starting position again.

Regarding the structure of the polymer system comprising polymer particles and matrix

The polymer system gives rise to an optical effect, i.e. an observable reflection due to interference of the light scattered by the polymer particles.

The wavelength of the reflexion may be within the total electromagnetic spectrum, depending on the spacing of the polymer particles. The wavelength is preferably in the UV range, IR range and in particular in the range of visible light.

The wavelength of the observable reflexion depends, according to the known Bragg equation, on the interplanar spacing, in this case the spacing between the polymer particles arranged in a space lattice structure in the matrix.

In order that the desired space lattice structure with the desired spacing between the polymer particles is established, in particular the proportion by weight of the matrix should be appropriately chosen. In the preparation methods described above, the organic compounds, e.g. polymeric compounds, should be used in an appropriate amount.

The proportion by weight of the matrix is in particular such that a space lattice structure of the polymer particles which reflects electromagnetic radiation in the desired range forms.

The spacing between the polymer particles (in each case up to the mid point of the particles) is suitably from 100 to 400 nm if a color effect, i.e. a reflexion, in the range of visible light is desired.

Regarding use

According to the invention, the colored polymer systems are used for indicating the stress state of hygiene or medical articles adjacent to the body. In the case of a strain, the color the polymer system changes. The corresponding color change therefore makes it possible to determine whether an article is stretched too greatly, i.e. fits too tightly and may thus lead to injuries to the human or animal body or other impairments of wellbeing.

The medical articles are, for example, plasters or closures for dressings.

The hygiene articles are, for example, diapers or incontinence articles.

The hygiene or medical article may be completely or partly coated or impregnated with the polymer system. It is sufficient for a clearly visible region which is stretched through use of the article to be appropriately coated or impregnated.

In particular, the polymer system may also be applied to substrates, e.g. adhesive tapes or labels, by coating. The substrates should have sufficient extensibility and thus permit a color change of the polymer system as a result of a strain.

The coated substrate can be used for medical or hygiene articles. The substrate can be applied to the medical or hygiene articles in the areas which stretch during the use of the articles. The substrate may in particular simultaneously have further functions; in particular, they may be used for closing or fastening the medical or hygiene articles.

On stretching the medical or hygiene article or of parts of the article in particular the closure parts the color of the simultaneously stretched polymer system changes. The type of color change indicates the extent of the stretching.

It is therefore immediately recognizable whether medical or hygiene articles fit too tightly and impair wellbeing.

### EXAMPLES

Preparation of the polymers

The following working examples illustrate the invention. The emulsifiers used in the examples have the following compositions:

Emulsifier 1:30% strength by weight solution of the sodium salt of an ethoxylated and sulfated nonylphenol having about 25 mol/mol of ethylene oxide units.

Emulsifier 2:40% strength by weight solution of a sodium salt of a C12/C14-paraffin sulfonate.

Emulsifier 3:15% strength by weight solution of a linear sodium dodecylbenzenesulfonate.

The particle size distributions were determined with the aid of an analytical ultracentrifuge or with the aid of the capillary hydrodynamic fractionation method (CHDF 1100 Particle Size Analyzer from Matec Applied Sciences), and the P.I. value was calculated from the values obtained, according to the formula given here

P.I.=(D90−D10)/D50.

Unless stated otherwise, solutions are aqueous solutions.

The pphm data used in the examples are parts by weight based on 100 parts by weight of total monomers.

The abbreviations used for monomers have the following meanings: AS=acrylic acid, n-BA=n-butyl acrylate, DVB=divinylbenzene, EA=ethyl acrylate, MAS=methacrylic acid, MAMol=N-methylolmethacrylamide, NaPS=sodium persulfate.

### Example 1

### Preparation of an Emulsion Polymer

In a glass reactor provided with anchor stirrer, thermometer, gas inlet tube, dropping funnel and reflux condenser, a dispersion of 0.9 g (0.20 pphm) of polystyrene seed (particle size: 30 nm) in 500 ml of water is initially taken and heated in a heating bath with stirring, at the same time the air being displaced by passing in nitrogen. When the heating bath has reached the predetermined temperature of 85° C. and the reactor content has reached the temperature of 80° C., the introduction of nitrogen is stopped and an emulsion of 445.5 g of styrene (99.0% by weight), 4.5 g of divinylbenzene (1.0% by weight) and 14.5 g of emulsifier 1 (1.0 pphm) in 501.3 ml of water and 54.0 g of 2.5% strength aqueous solution of sodium persulfate (0.3 pphm) are simultaneously added dropwise in the course of 3 hours. After the solutions have been completely fed in, the polymerization is continued for 7 hours at 85° C. and then cooled to room temperature.

The dispersion has the following properties:

| solids content: | 29.6% by weight |
|---|---|
| particle size: | 255 nm |
| coagulum fraction: | <l g |
| pH: | 2.3 |
| polydispersity index: | 0.13 |
| refractive index: | 1.59 |

This example was repeated several times, the concentration of the seed particles being varied. The following table I gives an overview of the experimental results obtained.

TABLE I

| Example number | 1A | 1B | 1C | 1D | 1E | 1F | lG |
|---|---|---|---|---|---|---|---|
| Seed conc. | 0.20 | 0.15 | 0.10 | 0.053 | 0.30 | 0.53 | 3.16 |
| % by weight | | | | | | | |
| Solids content | 28.8 | 28.4 | 28.5 | 29.4 | 29.3 | 30.0 | 28.6 |
| % by weight | | | | | | | |
| Particle size | 256 | 280 | 317 | 357 | 222 | 188 | 125 |
| [nm] | | | | | | | |
| P.I. | 0.13 | — | — | 0.19 | — | — | 0.221 |

### Example 2

### Preparation of an Emulsion Polymer Having Core/Shell Morphology

In a glass vessel provided with anchor stirrer, thermometer, gas inlet tube, dropping funnel and reflux condensers, 300 g of the dispersion of core particles obtained in example 1A are initially taken and heated in a heating bath with stirring, at the same time the air being displaced by passing in nitrogen.

When the heating bath has reached the preset temperature of 85° C. and the reactor content has reached the temperature of 80° C. the introduction of nitrogen is stopped and
a) a mixture of 84.7 g (98.0% by weight) of n-butyl acrylate, 0.86 g (1.0% by weight) of acrylic acid, 5.76 g (1.0% by weight) of a 15% strength by weight solution of N-methylolmethacrylamide, 2.86 g of a 31% strength by weight solution (0.97 pphm) of emulsifier I and 12.4 g of water and
b) 17.3 g of 2.5% strength by weight aqueous solution of sodium persulfate (0.5 pphm)
   are simultaneously added dropwise in the course of 1.5 hours.

After the solutions have been completely fed in, the polymerization is continued for 3 hours at 85° C. Thereafter, the dispersion of core/shell particles obtained is cooled to room temperature.

The dispersion has the following properties:

| solids content: | 40.6% by weight |
|---|---|
| particle size: | 307 nm |
| polydispersity index (PI): | 0.16 |
| core:shell weight ratio: | 1:1 (calculated) |
| refractive index of the shell polymer: | 1.44 |

This example was repeated twice more, the concentration of the core particles and the core/shell weight ratio being varied. The following table 2 gives an overview of the experimental results obtained.

TABLE 2

| Example number | 2A | 2B | 2C |
|---|---|---|---|
| Core fraction | 100.0 | 133.3 | 225.0 |
| [parts by weight] | | | |
| n-BA [% by weight] | 98.0 | 98.0 | 98.0 |
| AA [% by weight] | 1.0 | 1.0 | 1.0 |
| MAMol [% by weight] | 1.0 | 1.0 | 1.0 |
| Shell:core ratio | 1:1 | 0.75:1 | 0.44:1 |
| Particle size [nm] | 301 | 308 | 284 |
| P.I. | 0.162 | 0.137 | 0.144 |
| Solids content | 39.4 | 40.6 | 35.2 |
| [% by weight] | | | |

% by weight for nBA, AA and MAMol are based on the shell.

Production of a reflecting layer

### Example 3A

15 g of the dispersion obtained according to example 2A are dried in a silicone rubber dish at room temperature. A luminescent effect color layer of rubber-like elasticity is obtained. When this is kept in a vacuum drying oven for 1 hour at 120° C. and then cooled to room temperature, this elasticity increases further and it shows a slight change of color. On stretching of the layer, this color changes with the stretching ratio from brown through green to violet.

### Example 3B

135 g of the dispersion obtained according to example 2A are mixed with 15 g of a finely divided, 20% strength by weight aqueous dispersion of a copolymer of 94% by weight of ethyl acrylate and 6% by weight of methacrylic acid, having a median particle size of 30 nm and a glass transition temperature of about 0° C. and the mixture is dried in a silicone rubber dish at room temperature. An effect color layer which is mechanically even more stable than that obtained in example 3A is obtained. The example illustrates the facilitation and improvement of film formation by the copolymer addition.

### Example 3C

20 g of the dispersion obtained according to example 2A are mixed with 2 g of diethylene glycol diethyl ether (DGDE) and diluted with 10 g of water, and the mixture is dried in a silicone rubber dish at room temperature. A luminescent effect color layer which is mechanically more stable than that obtained in example 3A is obtained. The example shows that addition of DGDE, too, permits film formation of the shell polymers also at room temperature but has only a slight influence on the color of the layer which has formed the film.

### Example 4

15 g of the dispersion obtained according to example 2C are dried in a silicone rubber dish at room temperature by evaporating water. Thereafter, the luminescent effect color layer obtained is kept in a vacuum drying oven for 1 hour at 120° C. and then cooled to room temperature. A hard, mechanically stable, transparent film which has a luminescent color changeable with the angle of illumination and angle of use is obtained. By adding a finely divided soft dispersion analogously to example 3B and/or by adding plasticizers analogously to example 3C, it is possible to reduce the hardness of the layer if required so that, on stretching of the layer or pressing of the layers, color changes occur analogously to example 3A.

### Example 5

If the particle size of the seed used is changed in example 2A, i.e. for example the seed 1D is used instead of the seed 1A, the color impression of the films produced analogously to example 3A shifts to the longer wavelength range of the color spectrum. Accordingly, by using a smaller seed particle, such as, for example seed 1G, the color impression of the layers obtained analogously to example 3A is shifted to the shorter wavelength range of the color spectrum.

1. The method of using colored polymer systems having a color which is changeable in the case of a strain and is intended for indicating the stress state of hygiene or medical articles adjacent to the body.

2. The method according to claim 1, wherein the polymer system is a system comprising polymer particles and a deformable material (matrix), the polymer particles being distributed in the matrix according to a defined space lattice structure.

3. The method according to claim 1, wherein the polymer particles are one or more particle types having a median particle diameter in the range from 0.05 to 5 μm, each particle type having a polydispersity index (PI) of less than 0.6, calculated according to the formula
P.I.=(D90−D10)/D50
where D90, D10 and D50 are particle diameters for which the following applies:
D 90: 90% by weight of the total mass of all particles have a particle diameter of less than or equal to D 90
D 50: 50% by weight of the total mass of all particles have a particle diameter of less than or equal to D 50
D 10: 10% by weight of the total mass of all particles have a particle diameter of less than or equal to D 10.

4. The method according to claim 1, wherein the discrete polymer particles have a glass transition temperature greater than 30° C.

5. The method according to claim 1, wherein the polymer particles and the matrix differ in the refractive index.

6. The method according to claim 1, wherein the matrix too consists of a polymeric compound.

7. The method according to claim 1, wherein the polymer particles are the core of core/shell polymers and the matrix is formed by film formation of the shell.

8. The method according to claim 1, wherein the spacing between the polymer particles is from 100 to 400 nanometers so that electromagnetic radiation in the range of visible light is reflected.

9. The method according to claim 1, wherein the hygiene or medical articles are completely or partly coated or impregnated with the polymer system.

10. The method according to claim 1, wherein the polymer system is applied to substrates, e.g. adhesive tapes or labels, by coating, and the coated substrates are used for medical or hygiene articles.
